(19) United States
(12) Patent Application Publication
(10) Pub. No.: US 2021/0158335 A1
(43) Pub. Date: May 27, 2021

(54) BLOCKCHAIN TOKENIZATION

(71) Applicant: OPENST LIMITED, Central (HK)

(72) Inventors: Benjamin BOLLEN, Berlin (DE); Nishith SHAH, Pune (IN); Sunil KHEDAR, Pune (IN); Jason GOLDBERG, Berlin (DE)

(21) Appl. No.: 16/580,441

(22) Filed: Sep. 24, 2019

Related U.S. Application Data
(60) Provisional application No. 62/735,359, filed on Sep. 24, 2018.

(51) Int. Cl. G06Q 20/36; G06F 16/23

(52) U.S. Cl. CPC G06Q 20/367; H04L 9/3242; G06F 16/2336

(57) ABSTRACT

A blockchain tokenization involving minting tokens on one blockchain that are backed by cryptoassets on a different blockchain. A node processor stakes an amount of cryptoassets on a value blockchain by transferring the amount of cryptoassets from a staker address on the value blockchain to an address of a smart contract on the value blockchain. The node processor, responsive to the staking, mints an amount of utility tokens on the utility blockchain. The amount of minted utility tokens are stored on the utility blockchain mapped to the staker address. The amount of minted utility tokens are backed by the amount of staked cryptoassets on the value blockchain at a fixed conversion rate between the amount of cryptoassets staked on the value blockchain and the amount of minted utility tokens on the utility blockchain.

### BACKGROUND

### Technical Field

Embodiments of the disclosed subject matter generally relate to blockchain tokenization and use of tokens. More specifically, the disclosed embodiments relate to the minting of tokens on one blockchain that are backed by cryptoassets on a different blockchain.

### Discussion of the Background

Tokenization is becoming an increasingly popular way for people to transfer value between each other. Tokenization refers to the creation of tokens, e.g., an algorithmically generated number, that protect peoples' personal payment information. For example, tokenization is used in mobile payment systems to provide payment in the form of one or more tokens without revealing the payor's person payment information, such as credit card or bank information. Thus, a payor transfers one or more tokens to a payee as payment for a product or service. The payee provides the received token(s) to an intermediary for conversion into, for example, a fiat currency. In this example, the intermediary is a trusted intermediary holding the payor's payment information (e.g., credit card or bank information) and accordingly the payee never obtains access to the payor's payment information, only the trusted intermediary does. The use of a trusted intermediary raises a number of problems, including a single point-of-failure to the system, i.e., any failure of the trusted intermediary causes the entire payment system to fail.

Another area where tokenization is becoming more common is for rewarding users of an application. For example, a company that distributes an application, such as a social media application, would like to reward users for performing certain actions, such as rewarding users for sharing content, interacting with other users' content, etc. This is typically performed by the company creating its own token system to distribute tokens to the company's users. Although this provides the company with absolute control over the distribution and exchange of tokens, users may find little value in tokens that are only redeemable through the company and only within the company's application (or other applications produced by the company). Thus, these types of tokens may not provide sufficient incentive to users to perform the actions desired by the company. Further, this requires the company to design and implement the software necessary to process the transactions, maintain the user balances, and process redemptions. Although this may not be a significant burden for large companies, this development may be outside of the core competencies of smaller companies and/or may introduce delays in the release of software, which can be incredibly detrimental to many companies operating in spaces where the first application to market is typically the one that is the most successful.

As an alternative, the company could create its tokens to be freely tradeable and redeemable for a cash value. This can raise legal implications for the company because the tokens may be considered by government entities, e.g., the United States Securities and Exchange Commission, as a security requiring registration and is subject to securities regulations. The costs to a company of complying with securities registration and regulations is typically too much for many companies to consider this alternative to tokenization.

Another alternative is for a company to employ cryptocurrency instead of tokens to reward users for performing desired actions. Although this eliminates the burden of securities registration and regulations, the value of cryptocurrencies has typically been quite volatile, sometimes experiencing large gains or losses within a very short period of time. Thus, although the user can be provided with something that can be used outside of the company's application and can be exchanged for a cash value, the company has no control over the underlying value of the rewards because the underlying value follows the volatile price gyrations of the cryptocurrency.

Another problem with using cryptocurrency as rewards is that the technology used to transfer the cryptocurrency may not be scalable enough to handle a high volume of transactions. Specifically, cryptocurrency is typically stored on a blockchain, which is a distributed ledger for the cryptocurrency. Transfer of cryptocurrency requires verification of the transaction and writing a new block containing the transfer to the blockchain. Because blockchain uses a distributed ledger without a trusted intermediary, the verification and writing of the transaction is performed by so-called “miners”, which are computers (also referred to as nodes) that perform the work and submit a proof of work to obtain a payment in the cryptocurrency. To ensure integrity to the blockchain, the proof of work is typically very resource intensive (i.e., it requires a considerable amount of memory and processing power) and can take some time to complete. For example, the Bitcoin blockchain can typically process a maximum of 3.3 to 7 transactions per second and the Ethereum blockchain can typically process only 15 transactions per second. If many companies adopted cryptocurrency for user rewards, the cryptocurrency's blockchain would quickly become overwhelmed and the companies would not be able to transfer the cryptocurrency to their users on a real-time, or even a near-real-time, basis.

Accordingly, there is a need for tokenization that provides for freely tradeable tokens having a redeemable underlying value and that is scalable and can process a large number of transactions per second.

### SUMMARY

According to embodiments, there is a method, which involves a node processor staking an amount of cryptoassets on a value blockchain by transferring the amount of cryptoassets from a staker address on the value blockchain to an address of a smart contract on the value blockchain. The node processor, responsive to the staking, mints an amount of utility tokens on the utility blockchain. The amount of minted utility tokens is stored on the utility blockchain mapped to the staker address. The amount of minted utility tokens is backed by the amount of staked cryptoassets on the value blockchain at a fixed conversion rate between the amount of cryptoassets staked on the value blockchain and the amount of minted utility tokens on the utility blockchain.

According to another embodiment, there is a method, which involves a node processor receiving a message to stake an amount of cryptoassets on a value blockchain. The node processor writes, responsive to the message to stake the amount of cryptoassets on the value blockchain, a new block on the value blockchain to reflect that a balances storage portion of an escrow smart contract on the value blockchain includes the staked amount of cryptoassets on the value blockchain mapped to a staker address. The node processor receives a message to mint an amount of utility tokens on a utility blockchain. The node processor, responsive to the message to mint the amount of utility tokens, writes a new block on the utility blockchain to reflect that a balances storage portion of an escrow smart contract on the utility blockchain includes the minted amount of utility tokens mapped to the staker address. The node processor receives a message to process the staked cryptoassets. The node processor, responsive to the message to process the staked cryptoassets, writes a new block on the value blockchain to reflect that a balances storage portion of a staked cryptoasset smart contract on the value blockchain includes the amount of staked cryptoassets on the value blockchain mapped to an address of the staked cryptoasset smart contract. The node processor receives a message to process the amount of minted utility tokens. The node processor, responsive to the message to process the amount of minted utility tokens, writes a new block on the utility blockchain to reflect that a balances storage portion of a utility token smart contract on the utility blockchain maps the amount of minted utility tokens to the staker address on the utility blockchain. The amount of minted utility tokens is backed by the amount of staked cryptoassets at a fixed conversion rate.

According to a further embodiment, there is a system, which includes a first node comprising a processor and storage. The first node stores a value blockchain in the storage and the processor is configured to execute a protocol of the value blockchain protocol. The system also includes a second node comprising a processor and storage. The second node stores a utility blockchain in the storage and the processor is configured to execute a protocol of the utility blockchain. The system further includes an interchain supervisor comprising a processor. The interchain supervisor is configured to control messaging between the first and second nodes to staked cryptoassets on the value blockchain to back utility tokens minted on the utility blockchain. There is a fixed conversion rate between the amount of cryptoassets staked on the value blockchain and the minted amount of utility tokens on the utility blockchain.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1A is a block diagram of a system according to embodiments;

FIG. 1B is a block diagram of a node according to embodiments;

FIG. 1C is a block diagram of a use-case for minted utility tokens according to embodiments;

FIGS. 2A-2C are high-level diagrams of a method according to embodiments;

FIG. 3A is a block diagram of a value blockchain according to embodiments;

FIG. 3B is a block diagram of a utility blockchain according to embodiments;

FIG. 4A is a diagram of the first phase of the two-phase minting process according to embodiments;

FIG. 4B is a diagram of the second phase of the two-phase minting process according to embodiments;

FIG. 4C is a diagram of the termination of the minting process due to a timeout according to embodiments;

FIG. 4D is a diagram of the reversion of minted utility tokens according to embodiments;

FIG. 5A is a diagram of the allocation of minted utility tokens to a beneficiary address according to embodiments;

FIG. 5B is a diagram of the redemption of minted utility tokens for value tokens according to an embodiment; and

FIGS. 6A-6J are tables illustrating the transfer of value and utility tokens according to the methods illustrated in FIGS. 4A-4D, 5A, and 5B.

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to the terminology and structure of blockchain technology.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

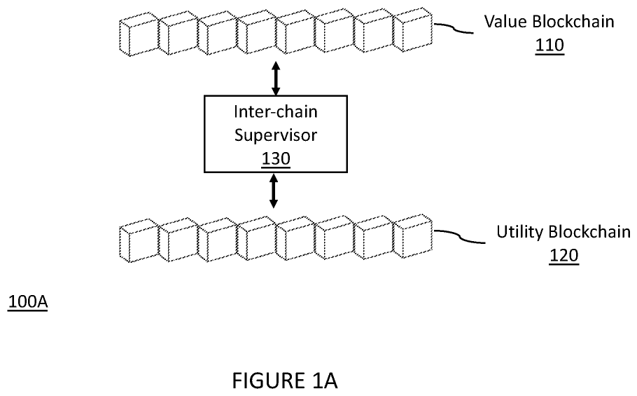

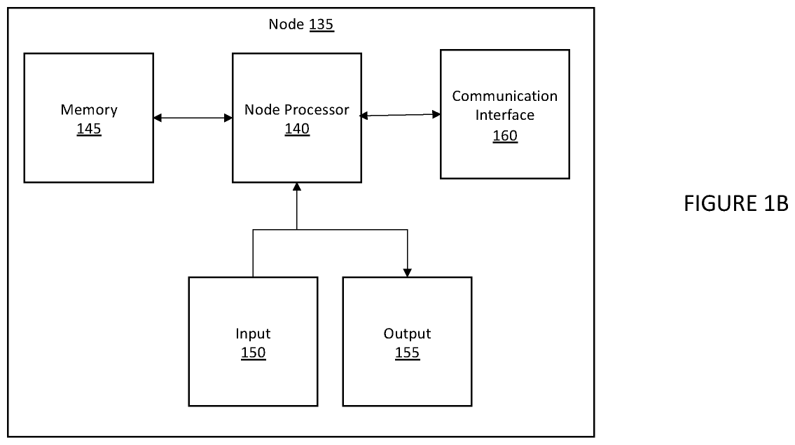

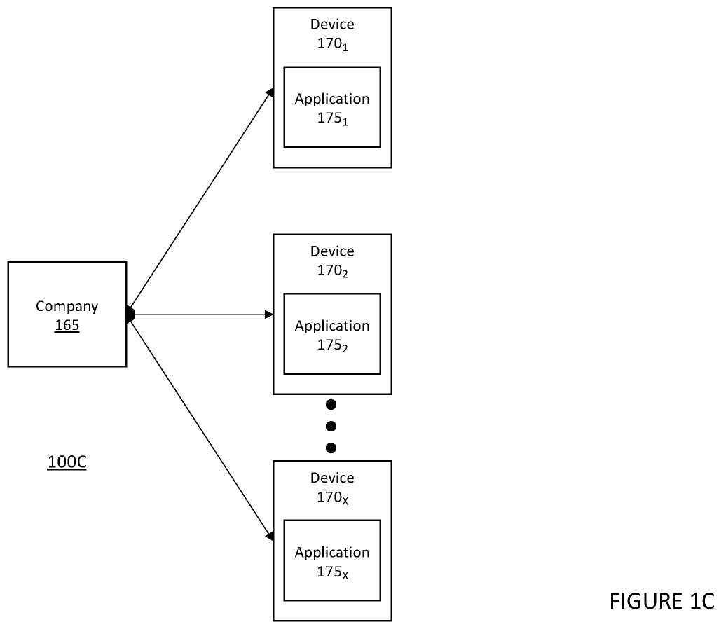

Exemplary embodiments of the present invention are directed to the staking of cryptoassets stored on a value blockchain to back utility tokens minted on a utility blockchain. Specifically, referring to FIG. 1A, an exemplary system 100 includes a value blockchain 110, a utility blockchain 120, and an inter-chain supervisor 130. The value blockchain 110 and utility blockchain 120 are each stored on a number of computing devices that execute the protocols of the respective blockchains, these computing devices are conventionally referred to as nodes. Transactions occurring on each of these blockchains are performed by each node so that these blockchains maintain the same state across all nodes, thereby ensuring the distributed ledger functionality that blockchains were designed to provide. A node can store and execute the protocol of only one of the value 110 and utility 120 blockchains or can store and execute the protocol of both of the value 110 and utility 120 blockchains.

The computing devices serving as nodes for either blockchain can be any type of computing device (e.g., a server, desktop computer, laptop computer, tablet, smartphone, etc.) that includes a memory for storing the blockchain and a processor for executing the protocol of a particular blockchain. FIG. 1B is a block diagram of an exemplary node 135 according to embodiments. The node 135 includes a node processor 140 coupled to a memory 145, an input 150, an output 155, and a communication interface 160.

The node processor 140 executes the protocol of one or more blockchains, including executing code (corresponding to functions) in one or more smart contracts on one or more blockchains. The memory 145 stores the entire ledger (i.e., the entire blockchain), as well as code for execution by the node processor 140 to perform its functions as a blockchain node. The input and output respectively provide for inputting to and outputting from the node processor 140. The communication interface 160 allows the node 135 to receive events from other nodes, publish events that are received by other nodes, send messages to other nodes, and receive messages from other nodes.

The types of components constituting a node processor 140, a memory 145, an input 150, an output 155, and a communication interface 160 can vary depending upon the type of computing device that is serving as a node. For example, the node processor 140 can be a microprocessor, application-specific integrated circuit (ASIC), field-programmable gate array (FPGA), and/or a graphics processing unit (GPU). The memory 145 can be any type of memory, including static and/or non-static memories. The input 150 can be any type of input device, including a keyboard, mouse, touchpad, trackpad, pen, etc. The output 155 can be any type of output device, including a display (which can be integrated in the node 135 or attached via a cable or wireless connection), a printer, etc. The communication interface 160 can be any type of wired or wireless communication interface. It should be recognized that the node 135 may be run in a headless mode without an output 155, and/or the node 135 need not include an input 150. It will be recognized that because the value 110 and utility 120 blockchains are executed by a number of nodes, the references to the processing performed by a node processor herein means that this processing is performed by the node processor of each node the executes one or both blockchains.

Returning to FIG. 1A, the interchain supervisor 130 serves in a trusted role between the value blockchain 110 and utility blockchain 120 to ensure that all applicable protocols are enforced on the respective blockchains. The interchain supervisor 130 monitors the value blockchain 110 and utility blockchain 120 and executes transactions on these blockchains using private keys. Specifically, the interchain supervisor 130 monitors the value 110 and utility 120 blockchains by executing these blockchains, and thus will be aware of any changes to the blockchains and any events related to the blockchains. In an embodiment, the interchain supervisor 130 can be a collection of applications and scripts, as well as person(s), that perform the monitoring and execution of transactions.

The disclosed embodiments provide for creating utility tokens on a utility blockchain 120 that are backed by an amount of cryptoassets stored on a value blockchain 110. For example, assume that the value blockchain 110 stores the amount of cryptoassets mapped to the address of a party that desires to mint the utility tokens, which address will be referred to herein as the staker address. Accordingly, a node processor 140 can stake an amount of cryptoassets on the value blockchain 110 by moving the amount of cryptoassets from a staker address to an address of a smart contract on the value blockchain 110. The node processor 140, responsive to the staking, can then mint an amount of utility tokens on the utility blockchain with the amount of minted utility tokens mapped to the staker address on the utility blockchain. There is a fixed conversion rate between the amount of cryptoassets staked on the value blockchain and the minted amount of utility tokens on the utility blockchain. In an embodiment, the fixed conversion rate is defined by the staker when the amount of cryptoassets is initially staked. It will be recognized that the addresses discussed herein are associated with a set of keys, a private key and a public key. The private key of an address is used to hash messages and the corresponding public key is used to verify the hashed messages to ensure that any transaction contained in a message is an authorized transaction.

The validation of transactions on the value blockchain 110 can be more secure than the validation of transactions on the utility blockchain 120. For example, the value blockchain 110 can require a proof of work validation, whereas the utility blockchain 120 can require a less secure cryptographic validation (e.g., a public-private key validation using hashing). This difference in security of transaction validations between the value blockchain 110 and the utility blockchain 120 leverages the more secure validation of transactions for the value blockchain 110 to provide quicker validation of transactions for the utility blockchain 120. For example, if it is assumed that the value blockchain 110 is an Ethereum blockchain, the staking of the cryptoassets to the address of a smart contract on the value blockchain 110 will be subject to the high security of the Ethereum proof of work validation. This proof of work validation is very resource intensive, and thus the Ethereum blockchain can process only about 15 transactions per second. In contrast, the less secure cryptographic validation for the utility blockchain 120 can process up to three hundred transactions per second. Thus, any attempted transfer of cryptoassets staked on the value blockchain 110 require the more secure validation required for this chain, whereas the transfer of the minted utility tokens on the utility blockchain 120 can be processed much more quickly using the less secure validation required for this chain. In other words, the invention leverages the high security validation of the value blockchain 110 to allow the use of a less secure and less resource intensive validation on the utility blockchain 120 allowing a greater transaction speed for the minted utility tokens.

An example use case of the system of FIG. 1A will now be described in connection with the block diagram of FIG. 1C. In this use case, a company 165 provides an application 175₁-175ₓ that is executed by one or more computing devices 170₁-170ₓ. Assume that the company 165 wishes to reward users of the computing devices 170₁-170ₓ for performing certain activities. For example, if the application 175₁-175ₓ is a social media application, users can be rewarded for posting information, liking information posted by others, helping others that are using the application 175₁-175ₓ, etc. As discussed in the Background section above, the existing ways of implementing such a reward system can involve significant monetary and manpower resources, which many companies may not be able to afford or may not want to develop considering these resources may be outside of the company's core competencies.

In contrast, using the systems and methods disclosed herein, the company 130 can stake cryptoassets on the value blockchain 110 in favor of utility tokens minted on the utility blockchain 120. Thus, the company can provide users of computing devices 1701-170X with rewards in the form of the minted utility tokens without requiring further validation of the transfer of the minted utility tokens on the value blockchain 110, and instead only requires validation of the transfer of minted utility tokens on the utility blockchain 120, which as mentioned above, is less secure is less resource intensive compared to the proof of work employed on the value blockchain 110. Similarly, users possessing minted utility tokens can redeem them with the company for something else of value without requiring further validation of the transfer of the minted utility tokens on the value blockchain 110, and instead only requires validation of the transfer of minted utility tokens on the utility blockchain 120.

However, because the minted utility tokens are backed by cryptoassets staked on the value blockchain 110, anyone holding minted utility tokens can redeem them for some of the staked cryptoassets mapped to the address of the smart contract on the value blockchain 110 at the conversion rate that was fixed when the utility tokens were initially minted. This can involve a node processor 140 receiving a redemption request, which includes the beneficiary address, for a quantity of the amount of minted utility tokens. The node processor 140 then reduces, responsive to the redemption request, the amount of minted utility tokens on the utility blockchain 120 by the quantity of the amount of minted utility tokens. The node processor 140 then transfers a quantity of the amount of staked cryptoassets from being mapped to the address of the smart contract on the value blockchain 110 to being mapped to the beneficiary address on the value blockchain 120. Because the quantity of the amount of staked cryptoassets are now stored under the beneficiary address on the value blockchain 120, the beneficiary is free to use the cryptoassets in any manner of its choosing.

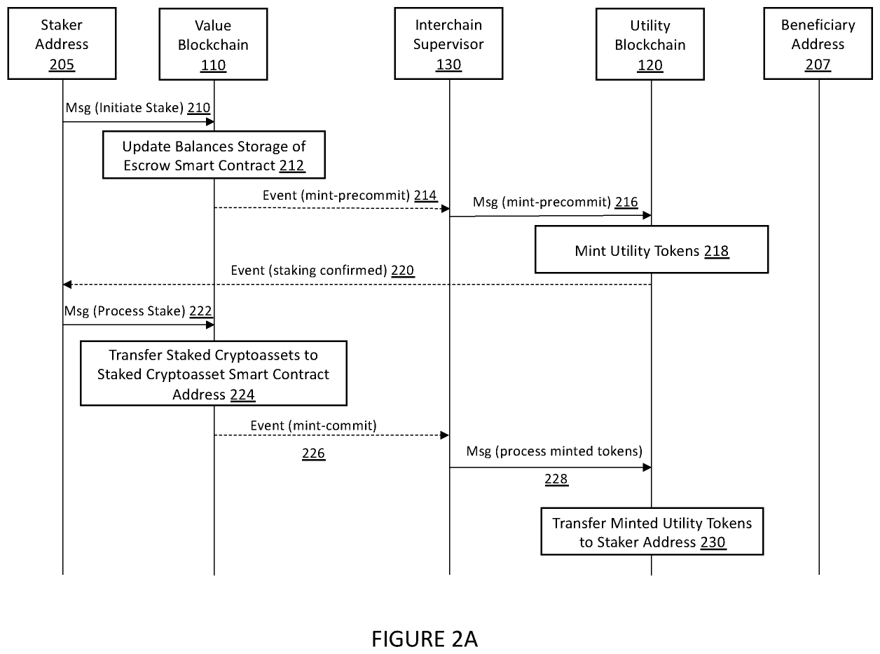

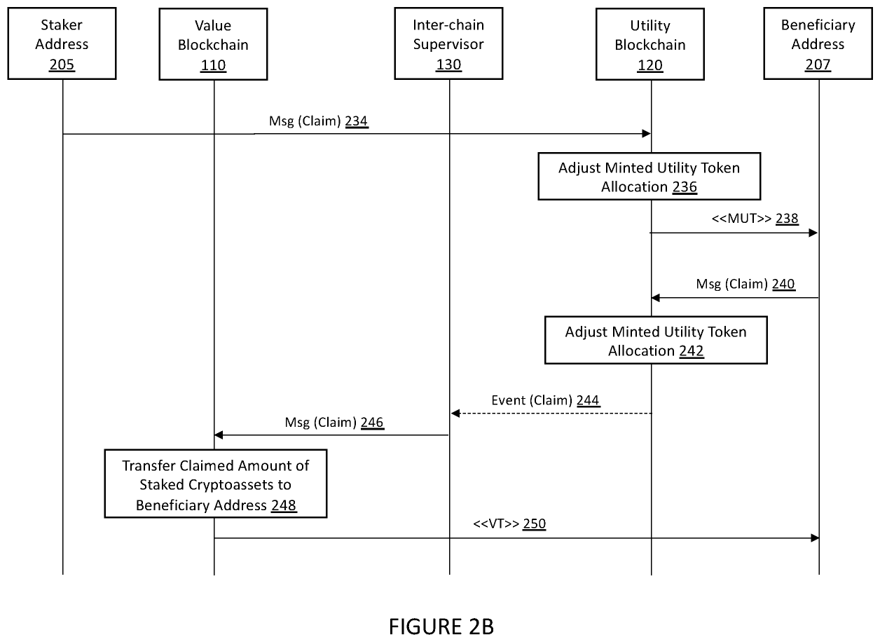

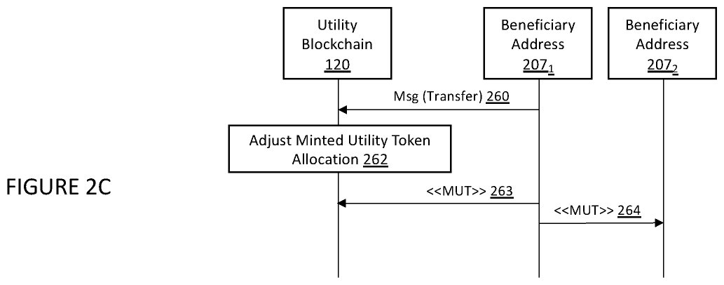

FIGS. 2A-2C are high-level diagrams of the methods described above. Specifically, FIG. 2A illustrates the two-phase minting process, FIG. 2B illustrates the allocation of minted utility tokens to beneficiaries and the redemption of allocated minted utility tokens by beneficiaries for a corresponding amount (at the fixed conversion rate) of the staked cryptoassets, and FIG. 2C illustrates the transfer of minted utility tokens between beneficiary addresses. As is conventional in the blockchain art, these figures are not pure call flows in which the lines represent messages sent between the various entities. Instead, some of the lines represent messages, whereas others illustrate the transfer of cryptoassets or minted utility tokens. For example, although these figures illustrate a staker address 205 and a beneficiary address 207 as separate entities from the value blockchain 110 and the utility blockchain 120, the staker address 205 and the beneficiary address 207 exist on both the value 110 and utility 120 blockchains, even if there is no value associated with one of these addresses on either or both blockchains. This distinction will become clearer in the description below.

Turning first to FIG. 2A, the two-phase minting process is initiated by hashing an initiate stake message with the private key of the staker address 205. This message can be generated by any entity holding the private key of the staker address 205, which can be the staker itself (e.g., an individual or company desiring to mint utility tokens) or by a trusted third party holding the private key for the staker address 205. This hashed message includes an amount of cryptoassets to be staked, a conversion rate between the cryptoassets to be staked and the utility tokens to be minted, and an address of an escrow smart contract on the value blockchain 110. Accordingly, this message is sent to the value blockchain 110 to initiate the staking process (step 210).

A balances storage portion of the escrow smart contract (also referred to below as the staking escrow smart contract) on the value blockchain 110 is updated to reflect the amount of staked cryptoassets are mapped to the staker address 205 on the value blockchain 110 (step 212). This transfer is recorded in a new block that is added to the value blockchain by a node processor 140.

The interchain supervisor 130 monitors the addresses associated with certain smart contracts (identified in more detail below) on the value blockchain 110 for certain events, which in this example is the address associated with the escrow smart contract. Accordingly, when the staking escrow smart contract emits an event evidencing that the balances storage portion of the staking escrow smart contract has been updated in the manner described above, this event, which is referred to as the mint-precommit, is received by the interchain supervisor 130 by virtue of its monitoring of the escrow smart contract on the value blockchain 110 (step 214). The interchain supervisor 130 then sends a message to the utility blockchain 120 indicating that cryptoassets have been escrowed on the value blockchain 110 for the minting of new utility tokens on the utility block chain 120 (step 216). An escrow smart contract on the utility blockchain 120 then mints a number of utility tokens and updates its balances storage portion to reflect that the minted utility tokens are mapped to the staker address 205 on the utility blockchain 120 (step 218). This is recorded in a new block that is added to the utility blockchain by a node processor 140.

The staker address 205 monitors the utility blockchain 120 for events, which in this example would be the minting of utility tokens on the utility blockchain 120. Accordingly, when the staker address 205 receives the event (step 220), as the result of the monitoring, the second phase of the minting process is initiated by sending a message, hashed with the private key of the staker address 205, to the address of the staking escrow smart contract on the value blockchain 110 (step 222). The staking escrow smart contract on the value blockchain 110, responsive to this message, sends a message to the address of a staked cryptoasset smart contract on the value blockchain 110 to update its balances storage portion to reflect that the staked cryptoassets should be mapped to the staker address 205 on the value blockchain 110 (step 224). This transfer is recorded in a new block that is added to the value blockchain 110 by a node processor 140. The transfer results in the staked cryptoasset smart contract on the value blockchain 110 emitting an event (step 226), which is received by the interchain supervisor 130 by virtue of its monitoring of the address of the staked cryptoasset smart contract for events.

The interchain supervisor 130, responsive to this event, sends a message to the address of the escrow smart contract on the utility blockchain 120 to transfer the minted utility tokens to the staker address on the utility blockchain 120 (step 228). The escrow smart contract on the utility blockchain 120, responsive to this message, sends a message to the address of the utility token smart contract on the utility blockchain 120 to update its balances storage portion to reflect that the minted utility tokens are mapped to the staker address 205 on the utility blockchain 120 (step 230). This transfer is recorded in a new block that is added to the utility blockchain by a node processor 140. The utility token smart contract contains code, which limits transfers of the minted utility tokens only in response to messages hashed with the staker private key.

Although FIG. 2A illustrates the message to process the stake (step 222) occurring before the message to process the minted utility tokens (step 228), these steps can occur in reverse order.

Turning now to FIG. 2B, assume that the staker now wants to transfer a quantity of the minted utility tokens to a beneficiary (e.g., the beneficiary performed a desired activity using an application). More specifically, the beneficiary performing the desired activity and the notification of this to the staker is performed, for example, within the staker application executed by a device of the beneficiary and a device of the staker is informed of the performance of the desired activity, i.e., this part of the process occurs off-chain and thus is not illustrated in the Figures. Accordingly, responsive to the staker being notified of the beneficiary performing a desired activity, a claim message, hashed with the staker's private key, is sent to the address of the utility token smart contract on the utility blockchain 120 (step 234). This message indicates the beneficiary address and the amount of minted utility tokens to be allocated to the beneficiary address 207. A node processor 140 receives this message and executes code in the utility token smart contract to adjust the minted utility token allocation consistent with the received message so that the intended amount of minted utility tokens is transferred from the staker address 205 to the beneficiary address 207 (step 236). The node processor 140 achieves this transfer of minted utility tokens by writing a new block to the utility blockchain 120 reflecting the transfer in the balances storage portion of the utility token smart contract on the utility blockchain 120. Accordingly, a quantity of the minted utility tokens (MUT) are now stored in the utility blockchain mapped to the beneficiary address 207 (step 238).

Consistent with the discussion above, the arrow from the utility blockchain 120 to the beneficiary address 207 transferring the minted utility tokens (step 238) is not an actual transfer out of the utility blockchain 120. Instead this arrow is an indication that the minted utility tokens are now associated (i.e., owned) by the beneficiary address 207.

Assume now that an entity holding the private key for the beneficiary address 207 desires to redeem the quantity of minted utility tokens for a corresponding amount (i.e., at the conversion rate fixed at the time of minting the utility tokens) of cryptoassets. This is initiated by sending a claim message, hashed with the beneficiary address 207, to the address of the utility token smart contract on the utility blockchain 120 (step 240). This message indicates an amount of minted utility tokens to be redeemed and that the redemption is for staked cryptoassets. A node processor 140 receives this message and executes code in the utility token smart contract to reduce the quantity of minted utility tokens mapped to the beneficiary address 207 by the amount of minted utility tokens being redeemed (step 242). The node processor 140 achieves this transfer of minted utility tokens by writing a new block to the utility blockchain 120 reflecting the reduced balance of minted utility tokens mapped to the beneficiary address 207. Because there is a fixed conversion rate between the staked cryptoassets and the minted utility tokens, the redemption of minted utility tokens for staked cryptoassets involves destroying (also referred to as burning) the redeemed minted utility tokens to maintain the fixed conversion rate. This is achieved by reducing the balance mapped to the redeemer's address without reallocating the redeemed minted utility tokens.

The node processor 140 then emits a claim event, which is received by the inter-chain supervisor 130, indicating that a quantity of minted utility tokens has been redeemed in favor of a corresponding amount (at the fixed conversion rate) of staked cryptoassets (step 244). The inter-chain supervisor 130, responsive to this event, sends a message to the address of the staked cryptoasset smart contract on the value blockchain 110 (step 246). A node processor 140 receives this message and executes code in that smart contract to adjust the staked cryptoassets consistent with the received message so that the intended amount of staked cryptoassets are mapped to the beneficiary address 207 on the value blockchain 110 and so that the amount of cryptoassets mapped to the staker address 205 are reduced by the redeemed amount of cryptoassets (step 248). Thus, the result of this transfer is that the intended amount of staked cryptoassets (e.g., value tokens VT) are transferred to the beneficiary address in the value blockchain 110 (step 250). This transfer is recorded in a new block that is added to the value blockchain 110 by a node processor 140.

In addition to the transfers discussed above, minted utility tokens can be transferred between different beneficiaries. For example, one user of an application can transfer a quantity of their minted utility tokens to another user of the application. The processing involved is illustrated in FIG. 2C. This process is initiated by sending a transfer message, hashed with the address of beneficiary 2071, to the utility token smart contract on the utility blockchain 120 (step 260). The message identifies a quantity of minted utility tokens to be transferred and the address of the beneficiary 2072 (i.e., the recipient) of the quantity of minted utility tokens. A node processor 140 executes code in the utility token smart contract to transfer the quantity of minted utility tokens from the beneficiary address 2071 to the beneficiary address 2072 (steps 262-264). This transfer is recorded in a new block that is added to the utility blockchain 120 by a node processor 140, the new block reflecting a decrease in the amount of minted utility tokens mapped to the beneficiary address 2071 and an increase in the amount of minted utility tokens mapped to the beneficiary address 2072.

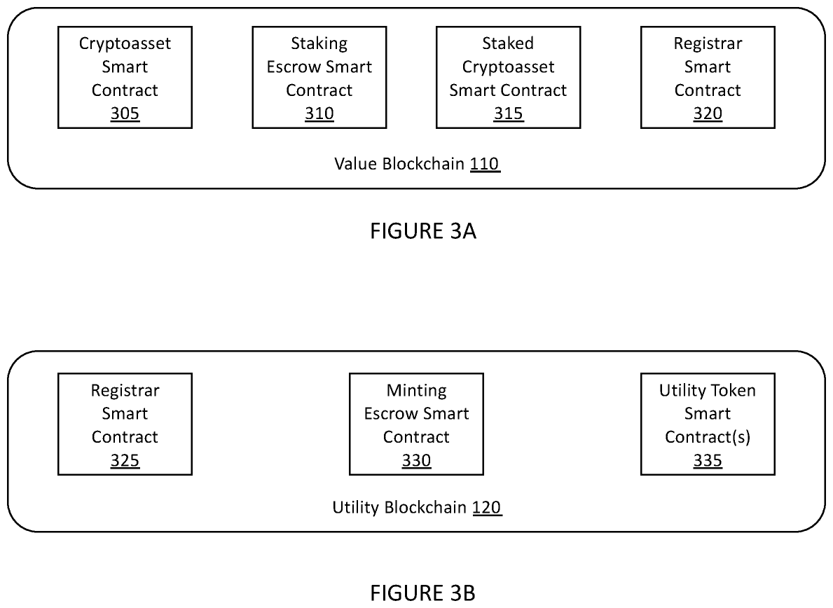

As noted in the discussed above, the value blockchain and utility blockchain each include number of different smart contracts. FIGS. 3A and 3B illustrate the smart contracts of the value blockchain 110 and utility blockchain 120, respectively. It will be recognized, however, that each of these blockchains can include other smart contracts than those illustrated in the figures.

Turning first to FIG. 3A, the value blockchain 110 includes a cryptoasset smart contract 305, a staking escrow smart contract 310, a staked cryptoassets smart contract 315, and registrar smart contract 320. Each of these smart contracts 305-320 has an address on the value blockchain 110 and stores code, which is executed by node processors 140 to perform the functions described herein.

The cryptoasset smart contract 305 is the smart contract that has a balances storage portion reflecting ownership of the cryptoassets that are used for staking in order to mint utility tokens. In this example, there is only one type of cryptoasset that is used for staking. However, the present invention can also be employed by staking other types of cryptoassets, in which case the value blockchain 110 includes a cryptoasset smart contract 305 for each of these other types of cryptoassets. Thus, for example, if the value blockchain 110 is an Ethereum blockchain, the value blockchain 110 can include a cryptoasset smart contract for Ether tokens. However, even if other types of cryptoassets cannot be used as a stake in favor of minted utility tokens and the value blockchain 110 is an Ethereum blockchain, the value blockchain 110 will still include a cryptoasset smart contract for Ether tokens, which would be used independent of the invention.

The cryptoasset smart contract 305 is deployed on the value blockchain 110 by the entity that also controls the inter-chain supervisor 130 and contains cryptoassets (e.g., tokens) that are generated by that entity. Thus, the entity that created these cryptoassets will have to attend to any governmental regulatory requirements in connection with the issuance of the cryptoassets, whereas a staker (e.g., a company supporting an application that will use the minted utility tokesn) that stakes these cryptoassets in favor of minted utility tokens will not. This arrangement allows stakers to easily deploy minted utility tokens without having to be involved with the complex governmental regulations typically required to issue new cryptoassets.

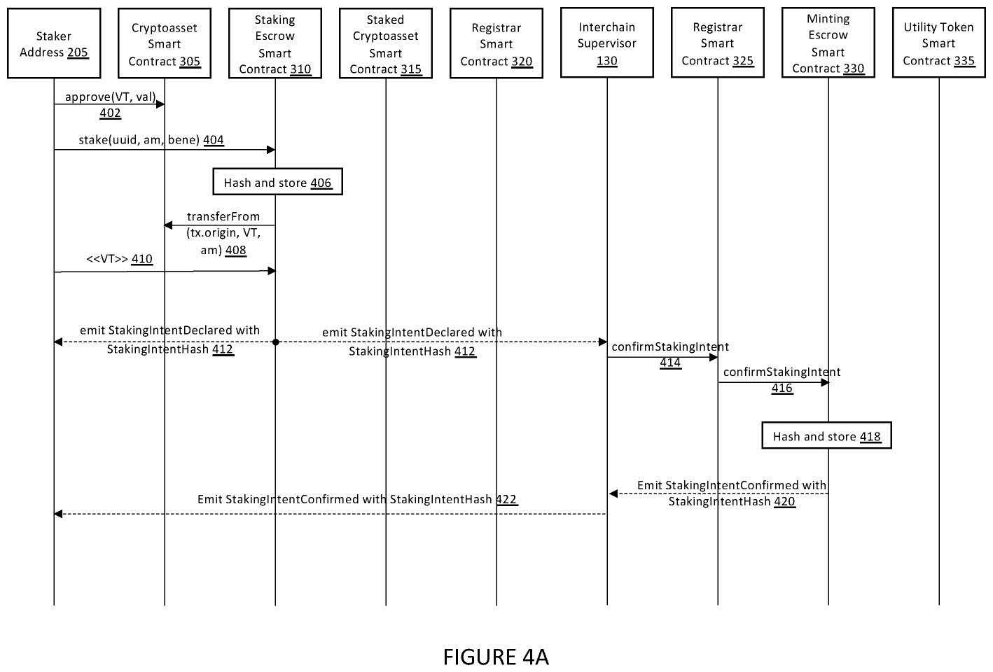

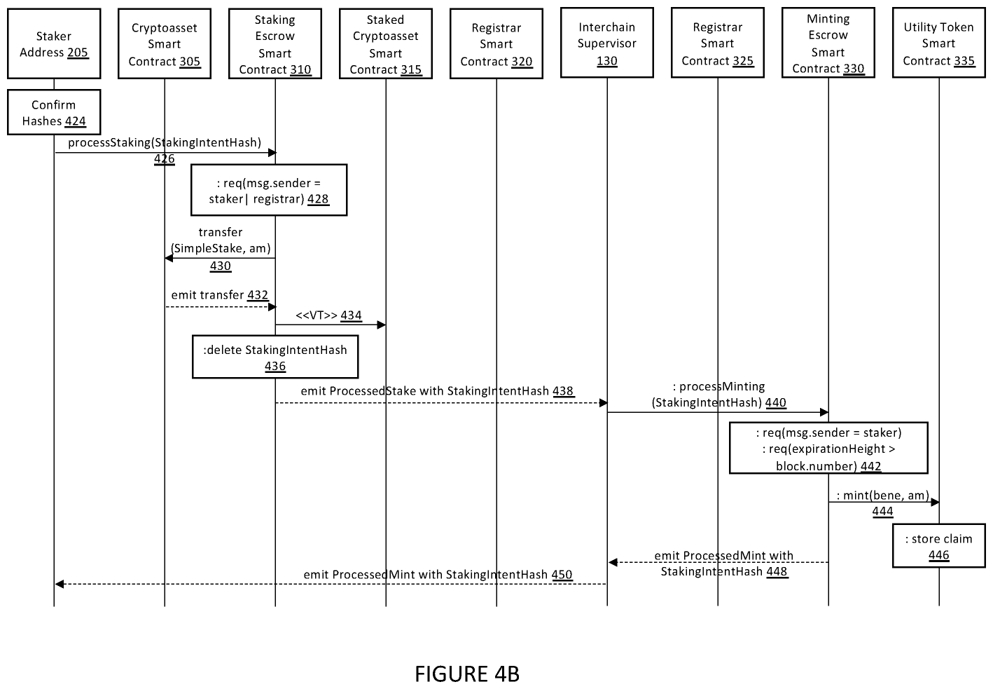

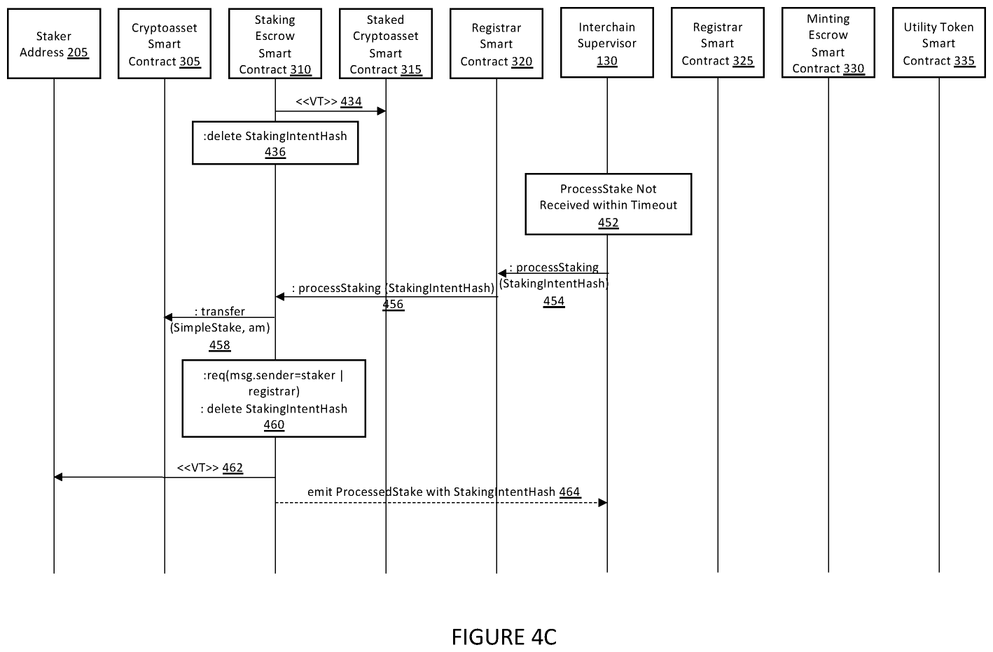

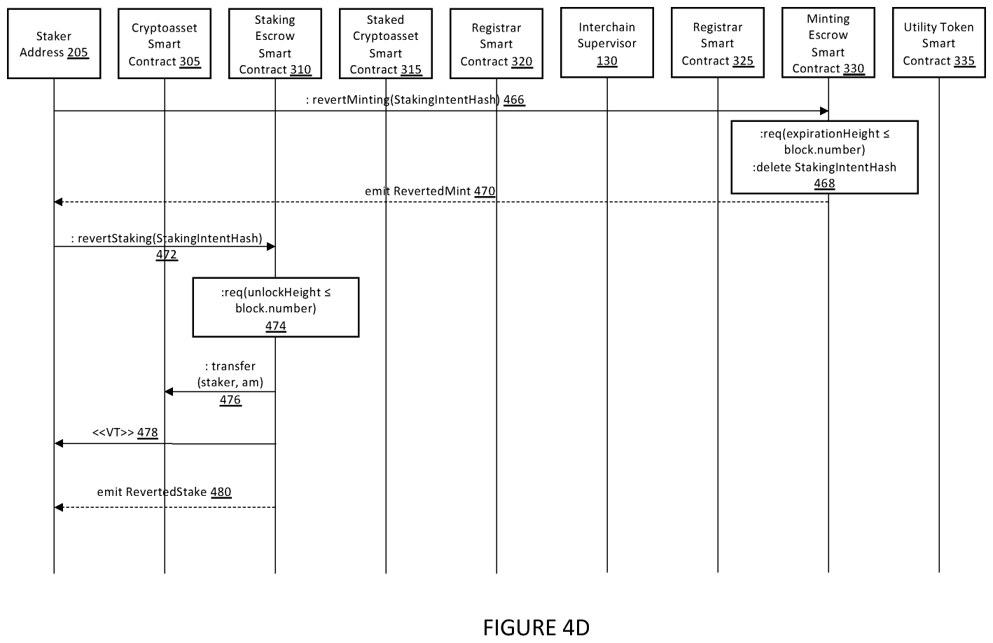

The staking escrow smart contract 310 is used to track the staker address 205 and the amount of staked cryptoassets. The staking escrow smart contract 310 acts as an escrow and initially transfers the staked cryptoassets to its own address in the first phase of the two-phase staking process, and then transfers them to the staked cryptoasset contract 315 once the utility tokens have been minted. Once the staked cryptoassets are transferred to the staked cryptoasset contract 315, the relationship between the staked cryptoassets and the staker address 205 are deleted from the staking escrow smart contract 310. If, however, there is a reversion before the completion of the second phase of the two-phase staking process (discussed below in connection with FIG. 4D), the stored relationship between the staker address 205 and the staked cryptoassets is used to return to the staked cryptoassets to the staker address 205. If, as in the process illustrated in FIG. 2B, a beneficiary desires to redeem minted utility tokens in favor of some of the staked cryptoassets, the staking escrow smart contract 310 will instruct the staked cryptoasset smart contract 315 to transfer a quantity of the staked cryptoassets corresponding to the quantity of redeemed minted utility tokens (at the fixed conversion rate) to the beneficiary address.

The staked cryptoasset smart contract 315 includes a balances storage portion that tracks the amount of staked cryptoassets, mapped to the address of the staked cryptoasset smart contract 315. The staked cryptoasset smart contract 315 is deployed on the value blockchain 110 for a utility token that is to be minted when the utility token is registered with the staking escrow smart contract 310. The examples disclosed herein involve staking cryptoassets in favor of minted utility tokens for the benefit of a particular staker. However, the present invention can also be employed to mint utility tokens of a number of different stakers, in which case there will be a staked cryptoasset contract 215 on the value blockchain for each of the number of different stakers.

The value blockchain 110 and the utility blockchain 120 each include a registrar smart contract, 320 and 325 respectively. The registrar smart contracts 320 and 325 are the smart contracts through which the inter-chain supervisor 130 performs the functions discussed herein. The registrar smart contracts 320 and 325 are respectively deployed on the value blockchain 110 and the utility blockchain 120 by the inter-chain supervisor 130 prior to deploying the staking escrow smart contract 310 and the minting escrow smart contract 330.

The minting escrow smart contract 330 generates the utility tokens (i.e., mints the utility tokens) and holds the minted utility tokens until the minted utility tokens are released to the utility token smart contract 335. Specifically, the minting escrow smart contract 330 contains code, which when executed by a node processor 140, creates a data structure in the first phase of the two-phase minting process. In the second phase, the information contained in this data structure is used to place the minted utility tokens in a position to be obtained by the staker, i.e., it is stored in the balances storage portion of the utility token smart contract 335 mapped to the staker address 205.

The utility token smart contract 335 is a contract deployed by the minting escrow smart contract 330 on the utility blockchain 120 to track the amount of minted utility tokens mapped to one or more addresses. This tracking is performed using the balances storage portion of the utility token smart contract 335. Accordingly, when the two-phase minting process is successfully completed, the balances storage portion of the utility token smart contract 335 reflects that all of the minted utility tokens are mapped to the staker address 205. As minted utility tokens are distributed to one or more beneficiaries, the amount of minted utility tokens mapped to the staker address 205 will be decreased by the amount that are transferred to the one or more beneficiary addresses, and the amount of minted utility tokens mapped to the one or more beneficiary addresses is increased by the amount transferred. In one embodiment, only the inter-chain supervisor 130, via the registrar smart contract 325, can register the utility token smart contract 335 with the minting escrow smart contract 330. Once registered with the minting escrow smart contract 330, the inter-chain supervisor 130, via the registrar smart contract 325, registers the minted utility tokens with the minting escrow smart contract 330.

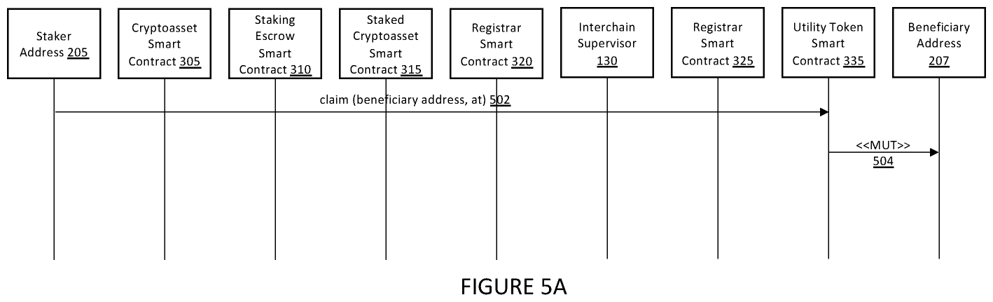

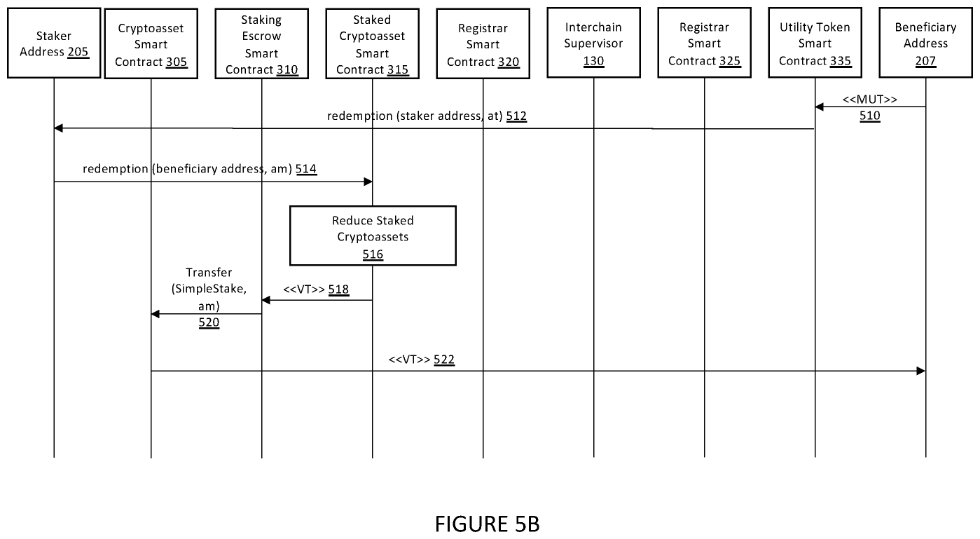

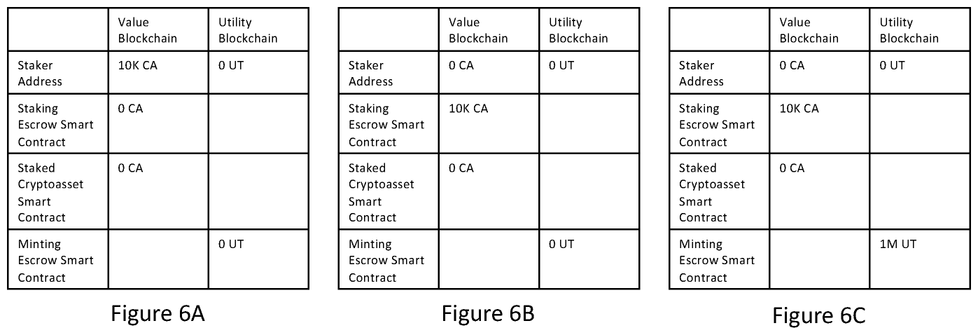

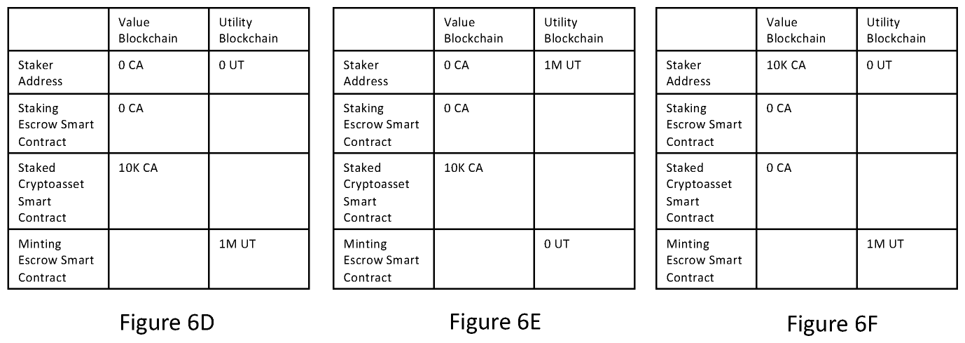

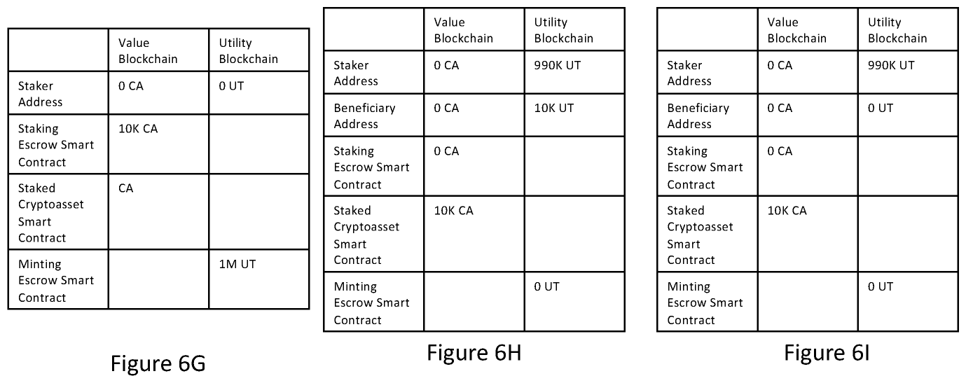

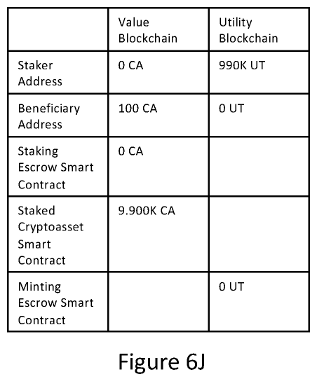

Additional aspects of the smart contracts described in connection with FIGS. 3A and 3B will be appreciated from the following discussion of FIGS. 4A-4D, 5A and 5B, which are more detailed diagrams of the methods disclosed above in connection with FIGS. 2A-2C. FIGS. 4A-4D, 5A, and 5B will be described in connection with the tables in FIGS. 6A-6J to illustrate the transfer of the cryptoassets and utility tokens.

Turning first to FIG. 6A, assume that there is currently ten thousand cryptoassets (which in the discussion below are also referred to as value tokens) mapped to the staker address 205 in the cryptoasset smart contract 305 on the value blockchain 110 that will be staked in favor of one million minted utility tokens. Because the utility tokens have not yet been minted, the table in FIG. 6A does not include any minted utility tokens. Turning now to FIG. 4A, when a staker desires to mint new tokens on the utility blockchain, a message (approve), hashed with the private key of the staker address 205, is sent to the address of the cryptoasset smart contract 305 on the value blockchain 110 to approve of the transfer of cryptoassets to the address of the staking escrow smart contract 310 (step 402). This message includes an amount of the value tokens being staked (VT) and the corresponding value in the utility tokens to be minted (val).

A message (stake), hashed with the private key of the staker address 205, is then sent to the staking escrow smart contract 310, instructing the staking escrow smart contract 310 to escrow the staked cryptoassets (step 404). This message includes the universally unique identifier of the staked cryptoassets (uuid), the amount staked (am), and an identification of the beneficiary (bene), which in this example is the staker address 205 because the utility tokens that will be minted are initially mapped to the staker address 205. The universally unique identifier of the staked cryptoassets (uuid) is an address of where the assets being staked are currently stored in the value blockchain 110. The universally unique identifier of the staked cryptoassets (uuid), the amount staked (am), and the identification of the beneficiary (bene) will be collectively referred to in the following as the staker intent data. Thus, as illustrated in FIG. 6B, the ten thousand cryptoassets that were stored on the value blockchain 110 mapped to the staker address 205 are now stored on the value blockchain 110 mapped to the address of the staking escrow smart contract 310.

A node processor 140, based on code stored in the staking escrow smart contract 310, hashes the staker's intent data with a staking sequence number, chain identifier (i.e., identifier of the value blockchain 110), and the escrow time-out block height (unlockHeight). The staking sequence number and chain identifier together form a nonce used for the hashing. The unique sequence number is used as part of the hash to avoid a replay attack. The node processor 140, executing code in the staking escrow smart contract 310, stores the hashed value as the StakingIntentHash, along with the nonce and the escrow time-out block height (unlockHeight) (step 406). This stored information is written to the value blockchain 110 in a new block.

A node processor 140, executing code in the staking escrow smart contract 310, sends a message (transferFrom) to code in the cryptoasset smart contract 305 to transfer the amount staked (am) from the staker address 205 to the address of the staking escrow smart contract (step 408). The transfer message includes an identification of the staker that will be transferring the cryptoassets (tx.origin), the amount of the value tokens being staked (VT), and the amount staked (am). Accordingly, a node processor 140 adds a new block to the value blockchain 110 that includes the amount of staked cryptoassets mapped to the address of the staking escrow smart contract 310 (step 410).

A node processor 140, executing code in the staking escrow smart contract 310, emits the StakingIntentDeclared event, which includes the StakingIntentHash (step 412). This event will be received by any node processor 140 that is monitoring the address of the staking escrow smart contract 310 for events. In this example, the interchain supervisor 130 and staker address 205 are monitoring the staking escrow smart contract 310 for events, and thus would receive this event. Specifically, as discussed above, the interchain supervisor 130 and staker address 205 each perform a full replication of the execution of the blockchain, and thus will be aware of any such events. Accordingly, the inter-chain supervisor 130, responsive to receipt of the emit StakingIntentDeclared event (step 412), sends a confirmStakingIntent message to an address of the registrar smart contract 325 (step 414). A node processor 140, executing code in the registrar smart contract 325, forwards the confirmStakingIntent message to the address of the minting escrow smart contract 330 (step 416).

A node processor 140, executing code in the minting escrow smart contract 330, mints an amount utility tokens corresponding to the amount in the approve message (i.e., in step 402), hashes the staker's intent data with the nonce (i.e., the staking sequence number and chain identifier (i.e., the identifier of the utility blockchain 120)), along with the nonce, the unlock height (unlockHeight), and the escrow timeout block height (unlockHeight) and stores the hashed value (StakingIntentHash) and an expiration time for storage of the minted utility tokens under the address of the minting escrow smart contract 330 (expirationHeight), which in the illustrated example is in terms of a block height (step 418). Accordingly, as illustrated in FIG. 6C, one million minted utility tokens are stored on the utility blockchain mapped to the address of the minting escrow smart contract 330.

A node processor 140, executing code in the minting escrow smart contract 330, emits a StakingIntentConfirmed event, which includes the StakingIntentHash (step 420). The interchain supervisor 130 monitors the address of the minting escrow smart contract 330, and thus receives this emitted event. Responsive to receipt of the emitted event, the interchain supervisor 130 emits this event, which is received by a node processor 140 monitoring the staker address 205 (step 422). This completes the first phase of the two-phase minting process so that the amount of cryptoassets staked for the minted utility tokens are mapped to the address of the staking escrow smart contract 310 and the minted utility tokens are mapped to the address of the minting escrow smart contract 330.

Turning now to FIG. 4B, the second phase of the two-phase minting process begins with a node processor 140, which is monitoring the staker address 205, confirming that the StakingIntentHash received from the StakingIntentDeclared event emitted by the staking escrow smart contract 310 (i.e., in step 412) matches the StakingIntentHash received from the StakingIntentConfirmed event emitted by the staked cryptoasset smart contract 315 (step 424). Once this is confirmed, a node processor 140, which is monitoring the staker address 205, sends a processStaking message, including the StakingIntentHash, to an address of the staking escrow smart contract 310 (step 426). Responsive to the processStaking message, a node processor 140, executing code in the staking escrow smart contract 310, confirms that the entity sending the message is the same as the staker (step 428). The notation in the message “Mesg.sender=staker|registrar” indicates that there is a requirement in the contract to check that the message was sent either by the staker or registrar.

A node processor 140, executing code in the staking escrow smart contract 310, then send a transfer message to the code in the cryptoasset smart contract 305, the message including an address of the staked cryptoasset smart contract 315 (SimpleStake) and the amount staked (am) (step 430). A node processor 140, executing code in the cryptoasset smart contract 305, emits a transfer event (step 432), which is received by code in the staking escrow smart contract 310. Responsive to this event, a node processor 140, executing code in the staking escrow smart contract 310, transfers the staked cryptoassets «VT» from the address of the staking escrow smart contract 310 to an address of the staked cryptoasset smart contract 315 (step 434), which is recorded in a new block written to the value blockchain 310. Thus, as illustrated in FIG. 6D, the ten thousand cryptoassets that were previously mapped to the address of the staking escrow smart contract 310 on the value blockchain 110 are now mapped to the address staked cryptoasset smart contract 315 on the value blockchain 110.

A node processor 140, executing code in the staking escrow smart contract 310, deletes the StakingIntentHash (step 436) and emits a ProcessedStake event, which includes the StakingIntentHash (step 438). The StakingIntentHash is deleted because once the staked cryptoassets are mapped to the address of the staked cryptoasset smart contract 315, it is no longer necessary to track which address originally staked the cryptoassets.

The interchain supervisor 130 monitors events emitted from the address of the staking escrow smart contract 310, and thus receives this emitted event. Responsive to receipt of the emitted event, the interchain supervisor 130 sends a processMinting message, which includes the StakingIntentHash, to an address of the minting escrow smart contract 330 (step 440). A node processor 140, executing code in the minting escrow smart contract 330, confirms that the hashed value (StakingIntentHash) matches the stored hashed value, and updates its records if the two values match (step 442). Specifically, node processor 140, executing code in the minting escrow smart contract 330, stores the staker's identity (msg.sender=staker) and confirms that the current block number of the utility blockchain 120 is less than the time-out value (expirationHeight) stored when the minted tokens were stored with the address of the minting escrow smart contract 330.

If the node processor 140 determines that the current block number of the utility blockchain 120 is less than the expiration height block number, the node processor 140, executing code in the minting escrow smart contract 330, sends mint message to the address of the utility token smart contract 335 (step 444). The message includes the staker address 205 (bene) and the amount staked (am). A node processor 140, executing code in the utility token smart contract 335, stores the minted utility tokens in the balances storage portion of the contract mapped to the staker address 205 (step 446). The current ownership on the respective blockchains of the staked cryptoassets and the minted utility tokens is reflected in the table illustrated in FIG. 6E.

A node processor 140, executing code in the minting escrow smart contract 330, emits a ProcessedMint event, including the StakingIntentHash, which is received by the interchain supervisor 130 by virtue of monitoring the address of the minting escrow smart contract 330 on the utility blockchain 130 (step 448). The interchain supervisor 130, responsive to this emitted event, emits the ProcessedMint event, including the StakingIntentHash (step 450). Thus, a node processor 140 monitoring the staker address 205 on the value blockchain 110 will receive this event and be aware that the two-phase minting process has been completed.

As discussed above, in the first phase of the two-phase minting process, the minted utility tokens are stored under the address of the minting escrow smart contract 330 (step 418) and FIG. 4B illustrates the processing when the second phase is performed within the timeout period (measured in this example in block height). FIG. 4C illustrates the processing occurring when the second phase of the two-phase minting process is not performed within the timeout period. Steps 434 and 436 in FIG. 4C are the same as those described above and are reproduced in this figure to provide context for the processing that follows.

When the interchain supervisor, which monitors the block height of value blockchain 110 and the address of the staking escrow smart contract 310 for the emit ProcessedStake event, determines that the address of the staking escrow smart contract 310 has not emitted the ProcessedStake event within the timeout period (step 452), the interchain supervisor 130 sends a processedStaking message, with the StakingIntentHash, to the address of the registrar smart contract 320 on the value blockchain 110 (step 454). Responsive to the processStaking message, a node processor 140, executing code in the registrar smart contract 320, sends a processStaking message, including the StakingIntentHash, to the address of the staking escrow smart contract 310 (step 456).

A node processor 140, executing code in the staking escrow smart contract and responsive to the processStaking message, sends a transfer message to the address of the cryptoasset smart contract 305 (step 458). The transfer message includes the address of the staked cryptoasset smart contract 315 (SimpleStake) and the amount of staked cryptoassets that should be reverted to the staker address 205. A node processor 140, executing code in the staking escrow smart contract 310, confirms that the message originated from either the staker's address or the registrar's address and deletes the StakingIntentHash (step 460). Accordingly, the staked cryptoassets are moved in the value blockchain 110 from being mapped to the address of the staking escrow smart contract 310 to being mapped to the staker address 205 (step 462), which is achieved by writing a new block with this transfer to the value blockchain 110. This transfer is illustrated in the table of FIG. 6F in which the ten thousand staked cryptoassets are stored on the value blockchain 110 with the staker address 205. As also illustrated in the table of FIG. 6F, the one million minted utility tokens maintain the mapping to the minting escrow smart contract 330 on the utility blockchain 120 because there are no staked cryptoassets backing these minted utility tokens. Accordingly, these minted utility tokens are inaccessible and cannot be placed into circulation at this time.

A node processor 140, executing the code in the staking escrow smart contract 310, emits a ProcessedStake message, including the StakingIntentHash, which is received by the interchain supervisor 130 due to its monitoring of the address of the staking escrow smart contract 310 for events (step 464). Thus, the interchain supervisor 130 is now informed that there are no staked cryptoassets for the minted utility tokens, and accordingly the interchain supervisor 130 prevents any further use of the minted utility tokens.

Assume now that the first phase of the two-phase minting process has been completed (i.e., the processing in FIG. 4A), the second phase has not (i.e., the processing in FIG. 4B), and the time-out period has not yet expired. Because the minted utility tokens are still mapped to the address of the minting escrow smart contract 330, and not mapped to the address of the utility token smart contract 335, the staker can revert the minting process and obtain the staked cryptoassets. This processing is illustrated in FIG. 4D. Prior to initiating this process, the mapping of the staked cryptoassets and the minted utility tokens on their respective blockchains is reflected in the table illustrated in FIG. 6C.

This process is initiated by sending a revertMinting message, hashed with the private key of the staker address 205 and including the StakingIntentHash, to the address of the minting escrow smart contract 330 (step 466). A node processor 140, executing code in the minting escrow smart contract 330, confirms that the timeout period, measured in terms of block number of the utility blockchain 120, has not yet expired (expirationHeight<=block.number), deletes the stored hashed value (delete StakingIntentHash) (step 468). Thus, as illustrated in the table of FIG. 6G, the one million minted utility tokens are still mapped to the address of the minting escrow smart contract 330 and the ten thousand staked cryptoassets are still mapped to the address of the staking escrow smart contract 310.

A node processor 140, executing code in the minting escrow smart contract 330, then emits a RevertedMint event, which is received by a node processor 140 monitoring the address of the minting escrow smart contract (step 470). A node processor 140, monitoring the address of the minting escrow smart contract 330 for events having the staker address 205, receives this emitted event and, responsive to this emitted event, the node processor 140 sends a revertStaking message, hashed with the private key of the staker address and including the StakingIntentHash, to the address of the staking escrow smart contract 310 (step 472).

Responsive to this message, a node processor 140, executing the code of the staking escrow smart contract 310, confirms that the timeout period for the escrow of the staking escrow smart contract 310 has not yet expired (unlockHeight<=block.number) (step 474), and sends a transfer message to the address of the cryptoasset smart contract 305 (step 476). The transfer message includes the staker address (staker) and the amount staked (am). The state of the staked cryptoassets is reverted to the state illustrated in FIG. 6A. Accordingly, the staked cryptoassets («VT») are then transferred from the address of the staking escrow smart contract 310 to the staker address 205 (step 478). This is reflected in the table illustrated in FIG. 6A in which the staked cryptoassets are no longer mapped to the address of the staking escrow smart contract 310 and instead are mapped to the staker address 205 on the value blockchain 110. Next, a node processor 140, executing code in the staking escrow smart contract 310, emits a RevertedStake event, which is received by a node processor 140 monitoring the value blockchain 110 for events containing the staker address 205 (step 480).

As discussed above in connection with steps 234-238 in FIG. 2B, the staker can distribute minted utility tokens to beneficiaries for performing desired actions within an application. The details of this processing on the blockchains are illustrated in FIG. 5A. In order to distribute minted utility tokens, a claim message, hashed with the private key of the staker address 205, is sent to the address of the utility token smart contract 335 on the utility blockchain 130 (step 502). The transfer message includes the beneficiary address 207 and the amount of utility tokens to be transferred to that address (at). A node processor 140, executing code in the utility token smart contract 335 and responsive to the claim message, transfers the amount of minted utility tokens («MUT») from the staker address 205 to the beneficiary address 207 (step 504). This is reflected in the table illustrated in FIG. 6H, which shows that ten thousand minted utility tokens are mapped to the beneficiary address 207 on the utility blockchain 130 and the nine hundred and ninety thousand minted utility tokens are mapped to the staker address 205 on the utility blockchain 130.

As discussed above in connection with steps 240-250 of FIG. 2B, a beneficiary holding minted utility tokens can redeem them for a corresponding amount (at the fixed conversion rate) of the staked cryptoassets. Details of the processing involved in this type of redemption is illustrated in FIG. 5B. The indication of a desire to redeem minted utility tokens in favor of a corresponding amount (at the fixed conversion rate) of staked cryptoassets occurs off-chain, and thus is not illustrated in FIG. 5B. Accordingly, assuming that the beneficiary has indicated a desire to redeem minted utility tokens for a corresponding amount (at the fixed conversion rate) of staked cryptoassets, a node processor 140 transfers the minted utility token from the beneficiary address on the utility blockchain 130 to the staker address 205 (step 510). This is achieved by writing a new block on the utility blockchain with the balances storage portion of the utility token smart contract 335 reflecting this transfer. Thus, as illustrated in the table of FIG. 6I, there are no longer any utility tokens stored with the beneficiary address 207 on the utility blockchain 130. Because the ten thousand utility tokens are being redeemed for a corresponding amount of staked cryptoassets (at the fixed conversion rate), the ten thousand minted utility tokens are mapped to another address so that these minted utility tokens cannot be redistributed and to maintain the fixed conversion rate. Otherwise, the value of the minted utility tokens would be diluted.

A node processor 140, executing code in the utility token smart contract 335 and responsive to this transfer, sends a redemption message to the staker address 205 (step 512). The message includes the staker address 205 and the amount of redeemed utility tokens (at). A node processor 140 monitoring the staker address 205 and responsive to receipt of the redemption message, sends a redemption message to the address of the staked cryptoasset smart contract 315 (step 514). The redemption message includes the beneficiary address and the amount of staked assets to be transferred to the beneficiary (am).

A node processor 140, executing code of the staked cryptoasset smart contract 315 and responsive to this redemption message, reduces the amount of staked cryptoassets by the amount in the redemption message (step 516). This is achieved by writing a new block on the value blockchain 110 indicating that the staked cryptoassets mapped to the address of the staked cryptoasset smart contract 315 are now mapped to the address of the staking escrow smart contract 310, which is reflected by the transfer of a quantity of the staked assets («VT») to the staking escrow smart contract 310 (step 518).

Responsive to this transfer, a node processor 140, executing code in the staking escrow smart contract 310, sends a transfer message to the address of the cryptoasset smart contract 305 (step 520). The transfer message identifies the type of cryptoassets to be transferred (SimpleStake) and the amount (am). Accordingly, the amount of staked cryptoassets are transferred from the address of staking escrow smart contract 310 to the beneficiary address 207 on the value blockchain 110 (step 522), which is achieved by a node processor 140 adding a new block to the value blockchain with the balances storage portion of the cryptoasset smart contract 305 reflecting this transfer. This is reflected in the table illustrated in FIG. 6J in which one hundred cryptoassets are stored with the beneficiary address 207 on the value blockchain 110, leaving nine thousand, nine hundred cryptoassets mapped to the staked cryptoasset smart contract 315.

It should be recognized that the names of the messages and the names of the contents of the messages described above are merely exemplary and that the messages and contents can have different names from what is described so long as the messages are used to perform the same functions that are disclosed.

The exemplary embodiments described above involve a staker staking cryptoassets in order to mint utility tokens on the utility blockchain. It should be recognized that the disclosed systems and methods can involve minting tokens for a number of different stakers. The methods described above will be performed similarly for the other stakers, the difference being that the utility blockchain 120 will have a different utility token smart contract 335 for each of the different stakers. The different utility token smart contracts 335 allow for different stakers to employ branded utility tokens (i.e., tokens named for the stakers' brand, such as their application that supports the use of the utility tokens) that are backed by cryptoassets on the value blockchain 110. Thus, although each staker's branded utility tokens can have different exchange rates to the staked cryptoassets on the value blockchain, any of the banded tokens can be redeemed for the corresponding amount (at the fixed conversion rate) of staked cryptoassets.

Further, because all of the branded utility tokens are staked at a set exchange rate against the staked cryptoassets, different branded tokens are freely exchangeable, accounting for the different exchange rates of the different branded tokens. This should increase user-uptake of the utility tokens because users are not locked into a token that only has value within the staker's application. Instead, users can exchange one type of branded token for another type, as well as redeem any type of branded token for a corresponding amount (at the fixed conversion rate) of the staked cryptoassets.

The ability to mint tokens on one blockchain backed by cryptoassets staked on another blockchain is significantly different than any other current use of two blockchains. For example, interledger protocol provides a way to exchange cryptoassets between two blockchains and requires a market-maker holding cryptoassets on both blockchains to act as an intermediary for anyone wanting to exchange cryptoassets on one blockchain in favor of cryptoassets on the other blockchain. Thus, unlike interledger protocol where the cryptoassets must be preexisting on both blockchains, the disclosed systems and methods create new tokens, i.e., the tokens did not previously exist on the blockchain prior to minting. Further, exchanging cryptoassets between two blockchains using interledger protocol involves a varying exchange rate, based on the underlying value of the different cryptoassets. In contrast, the present invention allows minting tokens backed by staked cryptoassets at a fixed exchange rate, which provides the advantages discussed above.

The disclosed embodiments provide systems and methods for blockchain tokenization. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

What is claimed is:

1. A method, comprising:
staking, by a node processor, an amount of cryptoassets on a value blockchain by transferring the amount of cryptoassets from a staker address on the value blockchain to an address of a smart contract on the value blockchain; and
minting, by the node processor responsive to the staking, an amount of utility tokens on the utility blockchain, wherein the amount of minted utility tokens are stored on the utility blockchain mapped to the staker address,
wherein the amount of minted utility tokens are backed by the amount of staked cryptoassets on the value blockchain at a fixed conversion rate between the amount of cryptoassets staked on the value blockchain and the amount of minted utility tokens on the utility blockchain.

2. The method of claim 1, wherein
the staking involves proof of work validation for adding a block containing the transfer of the amount of cryptoassets from a staker address to an address of a smart contract on the value blockchain, and
the minting involves a cryptographic validation for adding a block containing the amount of minted utility tokens on the utility blockchain.

3. The method of claim 2, wherein the cryptographic validation consumes fewer processing resources and is faster than the proof of work validation.

4. The method of claim 1, wherein the smart contract on the value blockchain is a staked cryptoasset smart contract, and wherein the staking further comprises:
transferring, by the node processor responsive to a message to process the amount of cryptoassets, the amount of cryptoassets on the value blockchain from a staker address on the value blockchain to an address of a staking escrow smart contract on the value blockchain.

5. The method of claim 4, wherein the minting further comprises:
minting, by the node processor, the amount of utility tokens in a minting escrow smart contract;
updating, by the node processor, a balances storage portion of the staking escrow smart contract to store the amount of cryptoassets with an address of a staked cryptoassets smart contract on the value blockchain; and
updating, by the node processor, a utility token smart contract on the utility blockchain so that the amount of utility tokens are mapped to the staker address.

6. The method of claim 1, wherein a beneficiary, having a beneficiary address, performs an activity for a quantity of minted utility tokens, the method further comprising:
transferring, by the node processor, the quantity of minted utility tokens from the amount of minted utility tokens mapped to the staker address by updating a balances storage portion of a utility token smart contract on the utility blockchain to include the quantity of minted utility tokens mapped to the beneficiary address and reducing the amount of minted utility tokens mapped to the staker address by the quantity of minted utility tokens.

7. The method of claim 6, further comprising:
receiving, by the node processor, a redemption request for the quantity of minted utility tokens, wherein the redemption request is hashed with the beneficiary address;
reducing, by the node processor responsive to the redemption request, the quantity of minted utility tokens on the utility blockchain mapped to the beneficiary address; and
transferring, by the node processor, a quantity of the amount of staked cryptoassets from the address of the smart contract on the value blockchain to the beneficiary address on the value blockchain,
wherein the quantity of the amount of staked cryptoassets is based on the fixed conversion rate.

8. The method of claim 1, wherein a quantity of the amount of minted utility tokens are stored on the utility blockchain mapped to a beneficiary address and a remainder of the amount of minted utility tokens are stored on the utility blockchain mapped to the staker address, the method further comprising:
receiving, by the node processor, a message to redeem the quantity of minted utility tokens;
transferring, by the node processor, the quantity of minted utility tokens from the beneficiary address on the utility blockchain to the staker address on the utility blockchain.

9. The method of claim 1, wherein a quantity of the amount of minted utility tokens are stored on the utility blockchain mapped to a beneficiary address, the method further comprising:
receiving, by the node processor, a message to transfer the quantity of minted utility tokens to a second beneficiary address;
transferring, by the node processor, the quantity of minted utility tokens from the beneficiary address on the utility blockchain to the second beneficiary address on the utility blockchain.

10. The method of claim 1, wherein the staking of the amount of cryptoassets on the value blockchain is performed by the node processor using at least code stored in the smart contract on the value blockchain and the minting of the amount of utility tokens on the utility blockchain is performed by the node processor using at least code stored in a smart contract on the utility blockchain.

11. The method of claim 1, wherein
the node processor comprises a first node processor of a first computing device and a second node processor of a second computing device, and
the first node processor performs the staking and the second node processor performs the minting.

12. A method, comprising:
receiving, by a node processor, a message to stake an amount of cryptoassets on a value blockchain;
writing, by the node processor responsive to the message to stake the amount of cryptoassets on the value blockchain, a new block on the value blockchain to reflect that a balances storage portion of a staking escrow smart contract on the value blockchain includes the staked amount of cryptoassets on the value blockchain mapped to an address of the staking escrow smart contract;
receiving, by the node processor, a message to mint an amount of utility tokens on a utility blockchain;
writing, by the node processor responsive to the message to mint the amount of utility tokens, a new block on the utility blockchain to reflect that a balances storage portion of a minting escrow smart contract on the utility blockchain includes the minted amount of utility tokens mapped to a staker address;
receiving, by the node processor, a message to process the staked cryptoassets;
writing, by the node processor responsive to the message to process the staked cryptoassets, a new block on the value blockchain to reflect that a balances storage portion of a staked cryptoasset smart contract on the value blockchain includes the amount of staked cryptoassets on the value blockchain mapped to an address of the staked cryptoasset smart contract;
receiving, by the node processor, a message to process the amount of minted utility tokens; and
writing, by the node processor responsive to the message to process the amount of minted utility tokens, a new block on the utility blockchain to reflect that a balances storage portion of a utility token smart contract on the utility blockchain maps the amount of minted utility tokens to the staker address on the utility blockchain,
wherein the amount of minted utility tokens are backed by the amount of staked cryptoassets at a fixed conversion rate.

13. The method of claim 12, wherein
the writing of new blocks to the value blockchain involves a proof of work validation before the new blocks are written to the value blockchain,
the writing of new blocks to the utility blockchain involves a cryptographic validation before the new blocks are written to the utility blockchain, and
the cryptographic validation consumes fewer processing resources and is faster than the proof of work validation.

14. The method of claim 12, further comprising:
receiving, by the node processor, a message that a quantity of the amount of minted utility tokens are being claimed by a beneficiary having a beneficiary address;
writing, by the node processor, a new block on the utility blockchain to reflect that the balances storage portion of the utility token smart contract on the utility blockchain maps the quantity of minted utility tokens to the beneficiary address and maps a reminder of the amount of minted utility tokens to the staker address.

15. The method of claim 14, further comprising:
receiving, by the node processor, a message to redeem the quantity of the amount of minted utility tokens for an amount of the staked cryptoassets; and
writing, by the node processor, a new block on the utility blockchain to reflect that the balances storage portion of the utility token smart contract maps a reduced amount of minted utility tokens to the beneficiary address.

16. The method of claim 14, further comprising:
receiving, by the node processor, a message to transfer a subset of the quantity of minted utility tokens to a second beneficiary address; and
writing, by the node processor, a new block on the utility blockchain to reflect that the balances storage portion of the utility smart contract maps the subset of the quantity of minted utility tokens to the second beneficiary address.

17. The method of claim 12, wherein the node processor
writes the new block on the value blockchain to reflect that the balances storage portion of the escrow smart contract on the value blockchain includes the staked amount of cryptoassets on the value blockchain mapped to the staker address at least based on code stored in the escrow smart contract, and
writes the new block on the value blockchain to reflect that the balances storage portion of the staked cryptoasset smart contract on the value blockchain includes the amount of staked cryptoassets on the value blockchain mapped to the address of the staked cryptoasset smart contract at least based on code stored in the staked cryptoasset smart contract.

18. The method of claim 12, wherein the node processor
writes the new block on the utility blockchain to reflect that the balances storage portion of the escrow smart contract on the utility blockchain includes the minted amount of utility tokens mapped to the staker address at least based on code stored in the escrow smart contract on the utility blockchain, and
writes the new block on the utility blockchain to reflect that the balances storage portion of the utility token smart contract on the utility blockchain maps the amount of minted utility tokens to the staker address on the utility blockchain at least based on code stored in a utility token smart contract on the utility blockchain.

19. A system, comprising:
a first node comprising a processor and storage, wherein the first node stores a value blockchain in the storage and the processor is configured to execute a protocol of the value blockchain protocol;
a second node comprising a processor and storage, wherein the second node stores a utility blockchain in the storage and the processor is configured to execute a protocol of the utility blockchain; and
an interchain supervisor comprising a processor, wherein the interchain supervisor is configured to control messaging between the first and second nodes to staked cryptoassets on the value blockchain to back utility tokens minted on the utility blockchain,
wherein there is a fixed conversion rate between the amount of cryptoassets staked on the value blockchain and the minted amount of utility tokens on the utility blockchain.

20. The system of claim 19, wherein
the processor of the first node executes code stored in a smart contract on the value blockchain to stake the cryptoassets on the value blockchain; and
the processor of the second node executes code stored in a smart contract on the utility blockchain to mint utility tokens on the utility blockchain.

21. The system of claim 19, wherein the system includes
a plurality of first nodes, each comprising a processor and storage, each storing the value blockchain in the storage, and each processor is configured to execute the protocol of the value blockchain protocol; and
a plurality of second nodes, each comprising a processor and storage, each storing the utility blockchain in the storage, and each processor is configured to execute the protocol of the utility blockchain.
